(19) United States
(12) Patent Application Publication
(10) Pub. No.: US 2023/0372981 A1
(43) Pub. Date: Nov. 23, 2023

(54) COMPOSITIONS FOR REMOVING RESIN AND CERAMIC FROM A SURFACE OF AN OBJECT AND METHODS OF USING SUCH COMPOSITIONS

(71) Applicant: PostProcess Technologies, Inc., Buffalo, NY (US)

(72) Inventors: Matthew J. Noble, Buffalo, NY (US); Daniel Hutchinson, Buffalo, NY (US)

(21) Appl. No.: 18/031,053

(22) PCT Filed: Oct. 27, 2021
(86) PCT No.: PCT/US2021/056847

§ 371 Date: Apr. 10, 2023

Related U.S. Application Data
(60) Provisional application No. 63/107,881, filed on Oct. 30, 2020.

(51) Int. Cl. B08B 3/08; B08B 3/12; B28B 11/22; B33Y 40/20

(52) U.S. Cl. CPC B08B 3/08; B08B 3/12; B28B 11/22; B33Y 40/20

(57) ABSTRACT

Compositions or finishing solutions configured to remove unwanted material, such as uncured resin and ceramic filler, from surfaces of additively manufactured objects are disclosed herein. The finishing solutions may be configured to remove such uncured resin and ceramic filler through submersion of the object in the finishing solution and agitating the submerged object at an ultrasonic frequency, without subjecting the object to any subsequent mechanical acts (such as brushing, sanding, or bead blasting) to remove any remaining uncured resin and/or ceramic filler from the object. In one example, the finishing solution includes a first glycol ether and a second glycol ether and/or a high flash point hydrocarbon, wherein the finishing solution has a flash point of at least 93.3° C. In alternative examples, the finishing solution may also include a third glycol ether, a high flash point alcohol, and/or an acetate of a glycol ether.

This application claims the benefit of U.S. Provisional Patent Application No. 63/107,881, filed Oct. 30, 2020, which is hereby incorporated by reference in its entirety.

### FIELD

The following disclosure relates to compositions for removing unwanted material from a surface of an object. In particular, the disclosure relates to compositions for removing unwanted material, such as resin and ceramic compositions from a surface of an object made by additive manufacturing techniques such as three-dimensional (3D) printing. The disclosure also relates to methods of using such compositions or solutions in removing unwanted material, such as resin and ceramic compositions from an object.

### BACKGROUND

Additive manufacturing processes, such as 3D printing (e.g., Selective Laser Sintering (SLS), Stereolithography (SLA), fused deposition modeling (FDM), material jetting (MJ), electron beam (e-beam), etc.) provide significant advantages for many applications. Additive manufacturing processes enable the production of parts having complex geometries that would be difficult to make using traditional manufacturing techniques. Also, additive manufacturing processes enable the efficient production of low volumes of parts. However, some additive manufacturing processes produce parts that require removal of unwanted material, such as resin and ceramic. The unwanted material is produced during the printing portion of the additive manufacturing process and may be needed to support portions of the part as the part is being printed. After the printing portion of the process is completed, the unwanted material must be removed before the part can be used for its intended purpose.

The unwanted material itself may have a complex geometry and may also be extensive because it may support the object at a plurality of locations. Additionally, because additive manufacturing prints an object in discrete layers, the surface finish of an object may be rough because edges of the layers may not align precisely with each other, thus creating a rough, bumpy outer surface. This outer surface may be unappealing visually or may have stress concentrations or irregularities, which need to be removed before testing or use.

Some finishing solutions for additive manufactured parts may be capable of removing certain uncured materials or resins, but not ceramic components present in the resin composition. Other finishing solutions (such as isopropanol) may have a low flashpoint (e.g., less than 100° F. or 38° C.) and/or require precautions with which to work. Therefore, there has been a long felt need for a chemical finishing solution that overcomes such limitations and is capable of removing both resin and ceramic components present in a resin composition, wherein the finishing solution has a higher flashpoint and/or fewer working precautions or processing acts.

### SUMMARY

The disclosure provides compositions or finishing solutions for removing unwanted material (e.g., uncured resins and ceramic filler), such as from a surface of an object made by additive manufacturing techniques. In one embodiment, a finishing solution includes at least one glycol ether, a caustic solution, and at least one diol or triol. In certain examples, the finishing solution may also include one or more emulsifiers. In certain examples, the finishing solution has a flash point of at least 200° F. (93.3° C.). The finishing solution may be configured to remove the uncured resin and ceramic filler from a surface of the 3D printed object without subjecting the object to any subsequent mechanical acts (such as brushing, sanding, or bead blasting) to remove remaining uncured resin and/or ceramic filler from the object.

In another embodiment, the disclosure provides a method of removing uncured resin and ceramic filler from a partially cured three-dimensional (3D) printed object. The method includes providing a finishing solution having a glycol ether, a caustic solution comprising a caustic compound and water, and at least one diol or triol compound. The method further includes submerging at least a portion of the 3D printed object in the finishing solution. The method further includes agitating the portion of the 3D printed object in the finishing solution at an ultrasonic frequency. The method further includes removing the 3D printed object from the finishing solution. In such a method, uncured resin and ceramic filler is removed from a surface of the 3D printed object without subjecting the object to any subsequent mechanical acts (such as brushing, sanding, or bead blasting) to remove remaining uncured resin and/or ceramic filler from the object.

In another embodiment, the disclosure provides a finished three-dimensional (3D) printed object formed through a process that includes: providing a partially cured 3D printed object having an uncured resin and ceramic filler on a surface of the partially cured 3D printed object; providing a finishing solution having a glycol ether, a caustic solution comprising a caustic compound and water, and at least one diol or triol compound; submerging at least a portion of the partially cured 3D printed object in the finishing solution and agitating the portion of the 3D printed object in the finishing solution at an ultrasonic frequency, wherein the uncured resin and the ceramic filler are removed from the surface of the partially cured 3D printed object; and removing the 3D printed object from the finishing solution to provide the finished 3D printed object.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts a flow diagram of an exemplary method of using a finishing solution.

FIG. 2A depicts an example of a machine configured to be used to finish a 3D-printed object with a finishing solution.

FIG. 2B is a cross-sectional view of the machine depicted in FIG. 2A, as identified by the cross-section ‘2B’ in FIG. 2A.

FIGS. 3A-3D depict examples of a 3D printed object (rook) made with an Accura Bluestone resin composition and how various finishing solutions may perform in removing unwanted material from the 3D printed object. Specifically, FIG. 3A depicts an example of the 3D printed object prior to application of any finishing solution, and FIGS. 3B-3D depict examples of the object following submersion in various finishing solutions.

FIGS. 4A-4E depict examples of a 3D printed object (rook) made with an Accura HPC resin composition and how various finishing solutions may perform in removing unwanted material from the 3D printed object. Specifically, FIG. 4A depicts an example of the 3D printed object prior to application of any finishing solution, and FIGS. 4B-4E depict examples of the object following submersion in various finishing solutions.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

As noted above, there are considerations to be addressed when working with certain prior commercially available finishing solutions such as isopropanol (IPA) to remove materials from additively manufactured polymers, resins, plastic materials, and parts. For example, some prior commercial finishing solutions have a low flash point, requiring safety precautions. Additionally, or alternatively, certain prior commercial finishing solutions may have a high vapor pressure, may be expensive, may require a large volume of material to remove a fixed amount of unwanted material, may be slow in removing such material, may require extra processing acts to remove ceramic components (e.g., silicon dioxide or silica) of a resin composition, or a combination thereof. As such, there has been a long felt need for a chemical finishing solution that overcomes such limitations.

Improved compositions or finishing solutions and their methods of making and use are disclosed herein.

Although the disclosure will be described in terms of certain embodiments, other embodiments, including embodiments that do not provide all of the benefits and features set forth herein, are also within the scope of this disclosure. Various structural, logical, and process step changes may be made without departing from the scope of the disclosure.

There are various 3D printed stereolithography (SLA) resin compositions that include both resin and a ceramic filler. The ceramic filler, such as silicon dioxide (SiO₂ or silica), may be provided within the resin composition for improved or increased stiffness, improved heat and/or abrasion resistance, and improved chemical resistance. In some embodiments, the silica is a fused silica, colloidal silica, or nanosilica filler component within the resin composition.

With SLA, a resin composition having a ceramic filler (e.g., silica) is partially cured with a laser during the print process. Unwanted material (e.g., the remaining uncured resin and ceramic filler) may be removed using a finishing solution formulated according to an embodiment of the present disclosure. Following removal of unwanted material, a post-cure process may be performed using a UV oven. In other words, the unwanted material that was not cured may be dissolved by a finishing solution of an embodiment before the object is placed into an ultraviolet (“UV”) curing chamber for final curing.

Certain commercially available solutions for removing both resin and ceramic from the 3D printed SLA resin composition have the disadvantages that such solutions have a low flashpoint (e.g., less than 100° F. or 38° C.), a high cost, and/or fail to remove a portion (e.g., a majority) of the ceramic filler from the surface of the 3D printed part without subsequent processing acts. In other words, commercially available solutions may leave a white powder silicon dioxide coating on a surface of the 3D printed part. Due to a lack of removal of a portion of the ceramic filler (e.g., the white powder coating), such commercially available solutions require additional (e.g., mechanical) processing acts following use of or submersion in the finishing solution, such as vigorous/labor intensive scrubbing with sandpaper, rasps, or files and/or dry/wet mechanical bead blasting to remove the remaining ceramic powder coating from the surface of the 3D printed part.

As disclosed herein, one or more finishing compositions or solutions and methods of use are provided for an improved removal of unwanted material (e.g., both resin and ceramic) from additively manufactured polymers, resins, plastic materials, or parts, e.g., without an additional (e.g., mechanical) processing act such as sanding, brushing, or bead blasting.

### Definitions

As used herein, the term “object” may refer to a 3D-printed object that is not in its desired final form.

As used herein, the term “finishing” may refer to removing unwanted material from an additively manufactured object (e.g., a 3D-printed object) so as to produce a finished or semi-finished part. Finishing may include one or more processes, including, but not limited to, removing uncured material, removing unwanted resin, removing unwanted metal powder, removing unwanted print material, and/or removing unwanted support material. In the 3D printing industry, finishing may also be referred to as “cleaning.”

As used herein, the term “unwanted material” may include uncured material or unwanted resin and/or ceramic filler. The unwanted material may be the same material as the object being manufactured or may be a different material. Examples of materials having both resin and ceramic filler that may be removed during finishing include, but are not limited to, Accura HPC, Accura Bluestone, SOMOS PerForm Reflective, SOMOS PerForm HW, Prodways Rigid 10500, and the like.

As used herein, the term “agitated” may refer to effecting movement by an outside force. With regard to the finishing solution, non-limiting examples of agitation include moving finishing solution via a pump, stirring, using longitudinal waves at an ultrasonic frequency, or combinations thereof.

### Compositions or Finishing Solutions

As disclosed herein, improved compositions or finishing solutions for post processing removal of unwanted or uncured material (e.g., uncured resin and ceramic components of the resin composition) may include (1) at least one glycol ether, (2) a caustic solution having a caustic compound and water, and (3) at least one diol or triol. Further, in some embodiments, the composition or finishing solution may also include at least one emulsifier. Various examples of types of compounds for each component and examples of weight percentages of each component are provided below. As defined below, the weight percentage examples are defined such that the total weight percent of the at least one glycol ether, the caustic compound of the caustic solution, the water of the caustic solution, the at least one diol or triol, and the at least one emulsifier (if present) add up to 100% (i.e., the total weight percent of these components ignores any additives or impurities that may be present within the finishing solution.

### Glycol Ethers

Examples of glycol ethers include, but are not limited to the following glycol ethers and acetates of glycol ethers: 2-Butoxy Ethanol (EB), Dipropyl Glycol Monomethyl Ether (DPM), Dipropylene Glycol Methyl Ether Acetate (DPMA), Ethylene Glycol Monohexyl Ether (aka 2-(Hexyloxy)ethanol) (aka 2-HEXOXYETHANOL) (HEX), Methyl Carbitol) (2-(2-Methoxyethoxy)Ethanol) (MC), Dipropylene Glycol n-Propyl Ether (DPnP), Ethyl Carbitol (2-(2-Ethoxyethoxy)Ethanol) (EC), Butyl Carbitol (2-(2-Butoxyethoxy)Ethanol) (BC), Propyl Carbitol (2-(2-Propoxyethoxy)Ethanol)) (PC), Dipropylene Glycol Butyl Ether (DPnB), Triethylene Glycol Dimethyl Ether (aka 1,2-Bis(2-methoxyethoxy) Ethane), 2-(2-Ethoxyethoxy)Ethyl Acetate (ECA), 2-(2-Butoxyethoxy) Ethyl Acetate (BCA), Dibutyl Carbitol (Diethylene Glycol Dibutyl Ether) (DC), Triethylene Glycol Monomethyl Ether (TM), Tripropylene Glycol Methyl Ether (TPM), Tripropylene Glycol n-Butyl Ether (TPnB), Triethylene Glycol Monoethyl Ether (TEGM), DPG (Dipropylene Glycol), Tetraethylene Glycol Dimethyl Ether (TTGD), and/or Triethylene Glycol Monobutyl Ether (aka BUTOXYTRIGLYCOL).

In certain examples, the amount of glycol ether present in the finishing solution may be in a range of 1-50 wt. %, 10-50 wt. %, 20-40 wt. %, 10-20 wt. %, or 20-30 wt. %.

### Caustic Solutions

In certain examples, the caustic solution may include a caustic compound and water. In some examples, the caustic compound is sodium hydroxide. In other examples, the caustic compound is potassium hydroxide or calcium oxide. The caustic solution within the finishing solution is advantageous in removing the ceramic filler (e.g., silica) from the surface of the 3D printed object. For example, a caustic solution including sodium hydroxide may assist in reacting with and dissolving the silica from the surface of the object.

The molarity of the caustic solution may be in a range of 0.1-10 M, 0.5-5 M, 0.5-1 M, 1-3 M, 3-5 M, or 5-10 M.

The amount of water present in the finishing solution may be in a range of 30-80 wt. %, 30-70 wt. %, 40-70 wt. %, 50-70 wt. %, 50-60 wt. %, or 60-70 wt. %.

The amount of caustic present in the finishing solution may be in a range of 0.1-30 wt. %, 0.5-30 wt. %, 0.5-20 wt. %, 1-30 wt. %, 1-20 wt. %, 1-10 wt. %, 10-20 wt. %, 1-5 wt. %, or 5-10 wt. %.

### Diols/Triols

As disclosed herein, a diol or triol may refer to a compound having two or more hydroxyl groups. In certain examples, the diol is an aliphatic diol or glycol. The glycol may include, but is not limited to, ethylene glycol, propylene glycol, 1,3-propanediol, 2-methyl-2,4-pentanediol, 1,4-butanediol, neopentyl glycol, 1,4-butanediol, 1,5-pentanediol, 1,6-hexanediol, 1,10-decanediol, or a combination thereof.

The diol/triol is advantageous in assisting with the removal of ceramic fillers (e.g., silica) from the surface of the 3D printed object. In particular, the diol/triol may be advantageous in improving the removal (e.g., dissolution) of the ceramic filler (e.g. silica) when provided in combination with a caustic solution. Further, the addition of the diol/triol component with a caustic solution may be advantageous in a reduced operating temperature for the finishing solution bath during the removal of the resins and ceramic fillers from the 3D printed part. That is, in certain examples, the operating temperature for the finishing solution may be in a range of 20-55° C., 20-40° C., 20-30° C., or ambient temperature conditions (e.g., 20-25° C.).

Further, in certain examples, the diol or triol may also be advantageous in functioning as its own emulsifier that keeps the components of the finishing solution (i.e., the organic components and the water) mixed together in solution.

In certain examples, the amount of diol/triol present in solution may be in a range of 1-50 wt. %, 10-50 wt. %, 20-40 wt. %, 10-20 wt. %, or 20-30 wt. %.

### Emulsifiers

In certain examples, one or more emulsifiers (or at least one additional emulsifier to the extent the diol/triol functions as an emulsifier) may be present in the finishing solution. The at least one emulsifier is advantageous in keeping the components of the finishing solution (i.e., the organic components and the water) mixed together in solution. As such, any emulsifier capable of keeping the glycol ethers, caustic, water, and diol/triols mixed together may be provided.

In some examples, the at least one emulsifier may be, but is not limited to, OGNTS (a micro-emulsion concentrate proprietary blend provided by Vitech International Inc.), sodium xylene sulfonate, methyl esters, Polysorbate 80, glycerol, Ampholak yjh-40 (a salt-free octyliminodipropionate concentrated proprietary emulsification blend by Nouryon Surface Chemistry), or combinations thereof.

In other examples, the emulsifier may be an amphoteric emulsifier. Non-limiting examples of amphoteric emulsifiers include Mackam 2CSF by Rhodia and Ampholak yjh-40 by Akzo Nobel.

In other examples, the emulsifier may be an anionic emulsifier. Non-limiting examples of anionic emulsifier include carboxylates (e.g., sodium benzoate), sulphonates, and alkylphenols.

In certain examples, the at least one emulsifier may include an additive component to stabilize the emulsifier component. The additive/stabilizer component may include a composition such as triethanolamine, stearic acid, or sodium stearate.

In certain examples, the amount of the one or more emulsifiers present in solution may be in a range of 0-20 wt. %, 0-5 wt. %, 0.1-20 wt. %, 0.1-5 wt. %, 0.1-3 wt. %, 0.1-2 wt. %, or 0.1-1 wt. %.

### Properties of Compositions/Finishing Solutions

In certain examples, the finishing solution provides a faster removal time of an unwanted material (e.g., resin) in comparison to IPA, such that a larger amount of resin or unwanted material may be removed (e.g., as measured in volume % or weight %) by the finishing solution described herein within a fixed amount of time when compared with a commercial finishing solution for a same amount of time. Alternatively, the faster removal time may be described as removing a fixed amount (vol. % or wt. %) of unwanted material in a shorter amount of time.

In certain examples, the finishing solutions described herein are capable of removing unwanted, uncured resin of the resin composition (e.g., as measured in volume % or weight %) from the surface of the 3D printed material with fewer or no additional post-processing (e.g., mechanical) acts such as sanding, brushing, or bead blasting. For example, the finishing solutions may be configured to remove at least 90 wt. %, at least 95 wt. %, or at least 99 wt. % of the unwanted, uncured resin from the surface of the 3D printed material without further sanding, brushing, or bead blasting acts.

Furthermore, the finishing solutions are advantageous in also removing unwanted ceramic filler components of the resin composition (e.g., as measured in volume % or weight %) from the surface of the 3D printed material with fewer or no additional post-processing (e.g., mechanical) acts such as sanding, brushing, or bead blasting. For example, the finishing solutions may be configured to remove at least 50 wt. %, at least 60 wt. %, at least 70 wt. %, at least 80 wt. %, at least 90 wt. %, at least 95 wt. %, or at least 99 wt. % of the ceramic from the surface of the 3D printed material without further sanding, brushing, or bead blasting acts. Such a finishing solution is advantageous in removing both unwanted, uncured resin and ceramic filler (e.g., silica) from the surface of the 3D printed material with a faster, less costly process that involves fewer or no subsequent processing acts following the printing and curing of a resin composition having a ceramic filler.

In certain examples, the finishing solutions described herein have a flash point of at least 200° F. (93.3° C.), at least 210° F. (98.9° C.), or at least 220° F. (104.4° C.). This may be advantageous, in comparison to commercial compositions such as isopropanol alcohol (IPA), in allowing for a reduced amount of equipment or safety protocols when using the finishing solution to remove unwanted material. Additionally, with such a flashpoint, the finishing solution may be configured to be used in a spraying application as described herein.

In certain examples, the finishing solution has an improved longevity in comparison to certain commercial finishing solutions such as IPA, wherein a greater amount of resin or unwanted material may be removed with a fixed volume of the finishing solution described herein (in comparison to a similar fixed volume of the commercial finishing solution such as IPA) before the finishing solution is saturated. For example, the finishing solutions described herein may dissolve at least 2 times, 3 times, 4 times, 5 times, 6 times, 7 times, 8 times, 9 times, or at least 10 times as much resin or unwanted material in comparison to a commercial finishing solution such as IPA.

In certain examples, the finishing solution has an improved odor (or lack thereof) in comparison to commercial solutions such as IPA.

In certain examples, the finishing solution is non-cytotoxic.

In certain examples, the finishing solution has a lower cost to use when compared with commercial solutions such as IPA.

### Methods of Use

In certain methods of use of the finishing solutions disclosed herein, an unfinished object (e.g., 3D-printed object) may be subjected to a process to remove unwanted material (e.g., both resin and ceramic filler) from the surface of the object, and thereby provide a finished part.

In one such method, the object is placed in a tank that has been filled (e.g., filled at least partially) with a liquid finishing solution. The object may be submerged in the finishing solution.

While the object is in the finishing solution (e.g., submerged in the finishing solution), the object may be subjected to application of mechanical energy, such as ultrasonic agitation, abrasion, and/or heating in order to remove unwanted resin from the object. Mechanical energy agitation may occur by moving the liquid finishing solution (e.g., via a pump) at an ultrasonic frequency. In such a process, the object is submerged and agitated using ultrasound to dissolve unwanted material including resin and ceramic filler (such as white powder silicon dioxide) from the surface of the object, and thereby create a finished or nearly finished form of the object. Ultrasonic agitation is advantageous in providing a blast of energy to the surface of the submerged object to help lift off unwanted material (e.g., the ceramic material) from the surface of the object.

Heat from a heat source may be used to maintain the finishing solution at a desired temperature. Under these conditions, the unwanted material may be removed thermally, chemically, mechanically or via a combination of two or more of these methods.

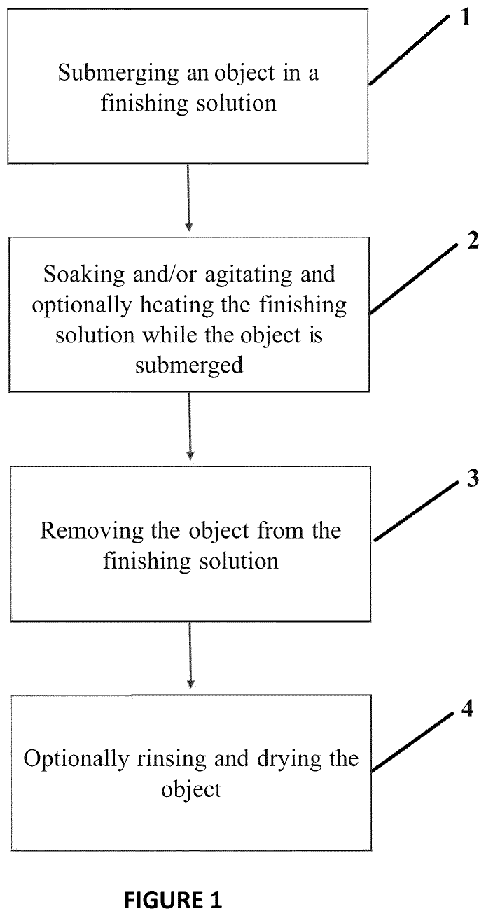

FIG. 1 depicts a flow diagram of an exemplary method of using a finishing solution. The steps of such a method may be sufficient to remove unwanted material from a 3D-printed object, build plate, or build tray. The method as depicted in FIG. 1 may include, in act 1, applying (e.g., by submerging the object) a finishing solution to an object or a portion thereof. Application of the finishing solution may be accomplished by submerging in the finishing solution all or part of the object that requires finishing. When used herein, the word “submerged” refers to a situation where the object is submerged at a depth sufficient to cover the object or portion thereof that requires finishing. The finishing solution may be stored in a holding vessel/container/tank. Non-limiting examples of materials that the holding vessel/container/tank may be made of include stainless steel, glass, high density polyethylene, Teflon, Kalrez, Polyvinylidene Fluoride (PVDF), and the like.

In FIG. 1, in act 2, the finishing solution may be soaked and/or agitated during at least part of the application. Agitation and/or vibration may be induced by methods such as, but are not limited to, sonication (e.g., via an ultrasonic transducer sending ultrasonic longitudinal waves into the finishing solution), a pump (e.g., using a pump to effect fluid movement), stirring, or a combination thereof. In certain specific examples, the agitation is conducted at an ultrasonic frequency.

Sonication may be performed at a power up to and including 1750 W, including all 0.1 W values and ranges below 1750 W, where power may vary temporally, and at a frequency of 20-100 kHz, including all 0.1 kHz values and ranges therebetween. In a preferred example, the frequency is 40 kHz. Sonicating a finishing solution may agitate the finishing solution such that the finishing solution does not separate into distinct phases and/or such that a force is applied to the object, or to move the finishing solution. Applying a force to the object helps dislodge and/or dissolve unwanted material. Such a finishing solution may be agitated for 1-60 minutes, including all 1 second values and ranges therebetween, prior to the object being submerged, and/or while the object is submerged.

The ultrasonic waves may be provided at a selected first agitation frequency. When agitated by the first frequency, the amplitude of the reflected ultrasonic waves may be detected by a sensor, and the amplitude of the reflected waves may be measured. Based on the measured amplitude, a second ultrasonic frequency may be selected, for example, using a database. Then ultrasound waves having the selected second ultrasonic frequency may be directed at the object. In this manner, the second ultrasonic frequency may be selected so as to optimally agitate.

This process may be repeated until the detected amplitude indicates (e.g., indicates through sensor feedback) that a resonant frequency of unwanted material has been reached. As unwanted material is removed, the resonant frequency of the remaining material may change, and so the process of selecting an ultrasonic agitation frequency may need to be repeated from time to time. When the desired run time has been reached, the object may be removed from the tank and inspected to determine whether additional run-time is needed. Additional run-time may be needed if the object is “tacky” or too rough.

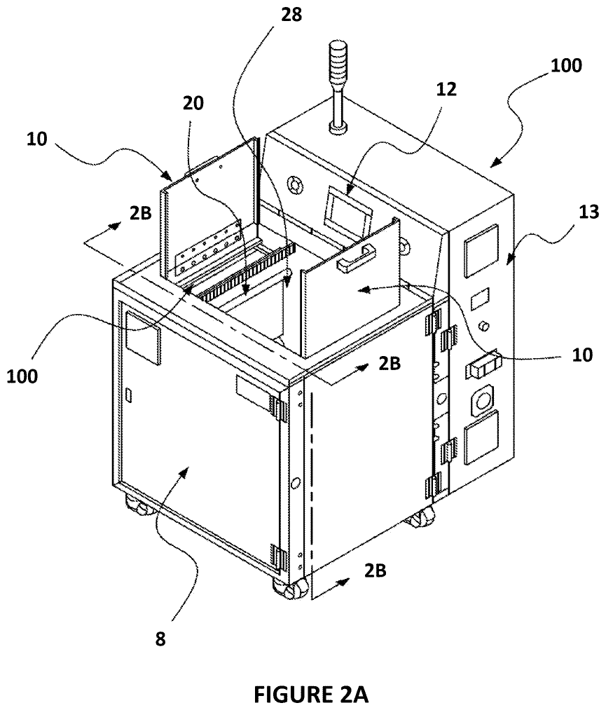

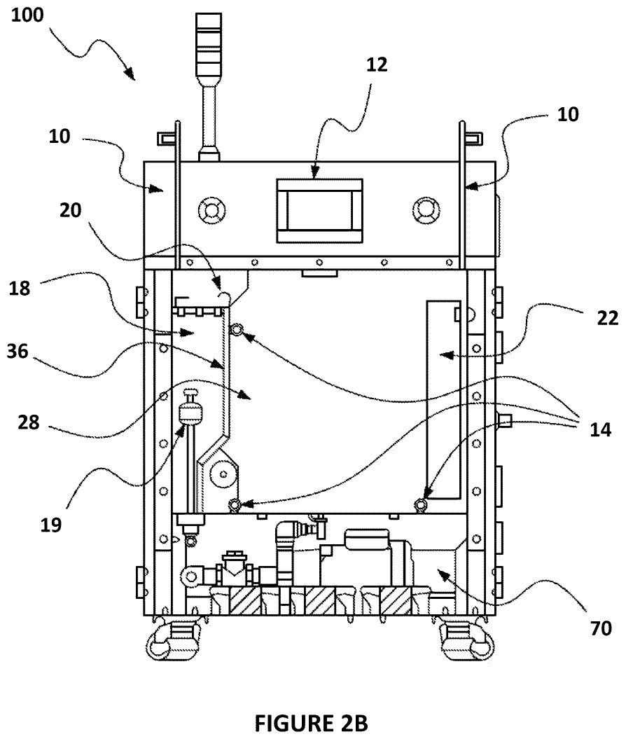

Referring to FIGS. 2A and 2B, agitation by a pump may include pumping a finishing solution into a tank (28) containing the object. For example, a finishing solution may be pumped into a tank (28) at a rate of 1-20 gallon/minute, including all 0.1 gallon/minute values and ranges therebetween. By pumping finishing solution into the tank (28), an equal amount of finishing solution may be made to flow out of the tank (28), over a weir (20) into an input tank (18), and then through a filter to a drain and back to the inlet of the pump. As the finishing solution is pumped into the tank (28), the solution entering the tank mixes with the finishing solution that was already in the tank. A finishing solution may be agitated for 1-60 minutes, including all 1 second values and ranges therebetween, prior to the object being submerged and/or while the object is submerged. Agitation prior to the object being submerged aids in mixing the finishing solution. Agitation after the object is submerged assists in removing unwanted material. Additionally, any other method to induce fluid movement may be suitable to induce such agitation (e.g., such as that induced by an ultrasonic generator (70)).

Stirring of the finishing solution may be performed by the use of an impeller, mechanical stirrer, stir bar, or the like. A finishing solution may be agitated for 1-60 minutes, including all 1 second values and ranges therebetween, prior to the object being submerged and/or while the object is submerged.

An object may be submerged in a finishing solution and agitated during at least part of the submersion. An object may be submerged for a time sufficient to remove unwanted resin. During such submersion, the finishing solution may be agitated during the entire time of submersion or during part of the time that the object is submerged. The amount of time may be 1-60 minutes, including all 1 second values and ranges therebetween. The amount of time needed to remove the unwanted material from the object may depend on the geometry of the object. For example, more complicated geometries may require additional submersion time. The object may be adequately finished by submerging the object for a time that is between 1 and 30 minutes, including all 1 second values and ranges therebetween, and the finishing solution may be agitated for the entire duration of submersion or during part of the time that the object is submerged.

Agitation of the finishing solution induced by stirring, a pump, and/or other methods, may create friction between the finishing solution and the object being finished, thereby assisting in removal of unwanted material. Removal of the unwanted material may be enhanced by ultrasonic transducers placed in the tank, such that the finishing solution vibrates, which is then imparted to the object. In an example, the ultrasonic transducers may be arranged on the side of the tank, and oriented tangential to the rotational flow of finishing solution in the tank. Such placement of the ultrasonic transducers achieves efficient agitation of the finishing solution and, thus, the submerged object. Sonication caused by ultrasonic transducers may enhance removal of unwanted material by causing cavitation at the surface of the unwanted material and the mechanical agitation caused by cavitation removes the unwanted material. Such cavitation may be useful because cavitation enhances removal of unwanted material.

The finishing solution may be heated to or maintained at a temperature to increase the rate of solubilization of unwanted resin. For example, the finishing solution may be kept at temperatures up to 55° C. (including all 0.1° C. values and ranges between ambient (i.e., 20-25° C.) and 55° C.), before the object is submerged and/or while the object is submerged. At higher temperatures, e.g., higher than 55° C., appropriate handling precautions may be taken.

A finishing solution may be recovered after the finishing operations are concluded. Steps for recovering the finishing solution may include allowing finishing solution to drip from the object back into a tank containing the finishing solution. The object may be rinsed with water or other suitable solvent. Such rinsing may be necessary to remove finishing solution that remains on the object. Following application of the finishing solution, the object may be rough and tacky. Tackiness is related to uncured resin remaining on the surface. Such determination for roughness and/or tackiness may be determined by personal/operator preference. Such a determination may be made by personal/operator touch. When an operator determines that the object is too rough or too tacky, then a method such as that described herein may be repeated until the desired roughness and/or tackiness is/are achieved. When the object has the desired (or lack thereof) tackiness and roughness, the operator may determine that the object no longer requires additional finishing.

Referring again to FIG. 1, in act 3, the object may be removed from the finishing solution. Additionally, in optional act 4, the object may be rinsed or dried.

In certain alternative methods, the object (or a portion of the object) may be sprayed with a finishing solution and the finishing solution may then be removed from the object.

FIG. 2A depicts an example of a machine configured to be used for certain methods described herein with the finishing solutions described herein to finish a 3D-printed object. FIG. 2B is a cross-sectional view of the machine depicted in FIG. 2A as identified by the cross-section ‘2B’.

FIGS. 2A and 2B depict a part finishing machine 100, a control panel 12, cover doors 10, a front panel 8, a tank 28 configured to hold a finishing solution (as described herein), a weir 20, a computer 13, an input tank 18, a liquid level sensor 19, a wall 36, an ultrasonic generator 70, a tank manifold 14, and ultrasonic transducers 22.

The part finishing machine 100 may be used in a method to finish a 3D-printed object by: (a) adding a finishing solution into a tank (28) of a machine (e.g., a machine (100) used for finishing a 3D printed object; (b) using a heater that is arranged in the tank (28) to heat the finishing solution to a desired temperature; (c) using a pump to move the finishing solution within the tank; (d) using an ultrasonic transducer (22) arranged relative to the tank to provide ultrasonic longitudinal waves and/or cavitation within the tank that agitate the finishing solution; and (e) contacting an object with the finishing solution for a desired time to remove unwanted material from the object.

Submersion in the finishing solution may weaken the unwanted material substantially by facilitating dissolution of the unwanted resin. Fluid flow and ultrasonic agitation provide some mechanical force to loosen weakened unwanted material, while also facilitating dissolution of unwanted material (e.g., uncured material and/or resin).

In certain examples, the method of using a finishing solution may be accomplished by using a machine manufactured by PostProcess Technologies, Inc. Examples of suitable machines include the DEMI (FIG. 1 shows a simplified schematic of a DEMI), CENTI, and FORTI. Embodiments of machines that can use the finishing solution to remove unwanted material from additively manufactured objects are disclosed in U.S. Patent Application Publication No. 2017/0348910, filed Jun. 1, 2016, the entire disclosure of which is incorporated by reference herein.

Additional agitation, such as from a pump and ultrasonic devices, may reduce the amount of time needed to remove unwanted material. Using such a machine may involve: (a) adding a finishing solution into a machine (100) from the top of the machine by lifting a lid (or other suitable mechanism to cover the tank (28), such as the cover doors (10) depicted in FIG. 2A and FIG. 2B) and pouring the finishing solution directly into a tank (28); (b) mixing the finishing solution (e.g., mixing may be performed by a pump and/or ultrasonic agitation) sufficiently so that the finishing solution does not separate; (c) heating the finishing solution via a submerged heater arranged in the tank, in order to heat the finishing solution to a desired temperature; (d) agitating the finishing solution using a pump and an ultrasonic device in order to move the finishing solution through the tank and agitate the solution and/or object at an ultrasonic frequency. As noted above, ultrasonic agitation is advantageous in providing a blast of energy to the surface of the submerged object to help lift off unwanted ceramic material from the surface of the object.

The machine may be filled with finishing solution using an automated filling feature having a pump and reservoir. A liquid level sensor (19) may be positioned in the tank (28) or input tank (18). When signals from that sensor indicate the liquid level is too low, a pump may be caused to move fluid from the reservoir to the tank (28). The solution may be premixed before being added to the reservoir. In addition, the finishing solution may need to be mixed after the finishing solution has been added to the tank (28) in order to prevent separation of the components.

A method of removing unwanted material may include placing a 3D-printed object within a tank of a machine, such as, for example, the machine depicted in FIG. 2A. A desired run time may be determined and/or selected, and the pump started so that the finishing solution is circulated through the tank by the pump. The method may involve: (a) placing an object in the finishing solution; (b) circulating the finishing solution through the tank (28) to cause the object to rotate within the finishing solution; and (c) directing ultrasonic energy waves at the object in the finishing solution so as to provide agitation and/or cavitation.

In another example, the finishing solution may be applied to the object by spraying the finishing solution on the object. Spraying may be accomplished by using a machine capable of spraying the object or using a spray bottle (e.g., a bottle having an atomizer nozzle). Embodiments of machines that can use the finishing solution to remove unwanted material from additively manufactured objects are disclosed in U.S. Patent Application Publication No. 2019/0202126, filed Dec. 17, 2017, the entire disclosure of which is incorporated by reference herein.

In another example, finishing of the object may be performed on a bench top using a mixer (e.g., a stir plate and magnetic stir bar, or a mechanical stirrer) and a tank (e.g., a flask or beaker) to hold the finishing solution (and object being finished). The object may be placed in the tank holding the finishing solution. While the object is in that finishing solution, the mixer applies a force to the finishing solution, such that the finishing solution is moved within the tank, and also applies a force to the object, whereby unwanted material is loosened from the object.

### EXAMPLES

Examples of various finishing solutions are disclosed herein.

### Example 1: By Weight (2.6 Molar Concentration NaOH in Water)

| | Actual | Percent | | Chemical |
|---|---|---|---|---|
| Chemical | Percent | Range | CAS # | Type |
| Butyl Carbitol | 27.1% | 1-50% | 112-34-5 | Glycol Ether |
| (2-(2-Butoxyethoxy)Ethanol) | | | | |
| Sodium hydroxide | 5.8% | 1-30% | 1310-73-2 | Caustic |
| Water | 56.8% | 30-70% | 7732-18-5 | Water |
| Propylene glycol | 10.0% | 0.1-30% | 57-55-6 | Diol |
| Vitech OGNTS Emulsifier | 0.3% | 0.1-20% | NA | Emulsifier |

### Example 2: By Weight (2.6 Molar Concentration NaOH in Water)

| | Actual | Percent | | Chemical |
|---|---|---|---|---|
| Chemical | Percent | Range | CAS # | Type |
| Butyl Carbitol | 27.1% | 1-50% | 112-34-5 | Glycol Ether |
| (2-(2-Butoxyethoxy)Ethanol) | | | | |
| Sodium hydroxide | 5.8% | 1-30% | 1310-73-2 | Caustic |
| Water | 56.8% | 30-70% | 7732-18-5 | Water |
| 2-Methyl-2,4-pentanediol | 10.0% | 0.1-30% | 107-41-5 | Diol |
| Vitech OGNTS Emulsifier | 0.3% | 0.1-20% | NA | Emulsifier |

### Example 3: By Weight (4.2 Molar Concentration NaOH in Water)

| | Actual | Percent | | Chemical |
|---|---|---|---|---|
| Chemical | Percent | Range | CAS # | Type |
| Butyl Carbitol | 43.2% | 1-50% | 112-34-5 | Glycol Ether |
| (2-(2-Butoxyethoxy)Ethanol) | | | | |
| Sodium hydroxide | 7.6% | 1-30% | 1310-73-2 | Caustic |
| Water | 45.3% | 30-70% | 7732-18-5 | Water |
| Propylene glycol | 2.6% | 0.1-30% | 57-55-6 | Diol |
| Vitech OGNTS Emulsifier | 1.3% | 0.1-20% | NA | Emulsifier |

### Example 4: By Weight (0.83 Molar Concentration NaOH in Water)

| | Actual | Percent | | Chemical |
|---|---|---|---|---|
| Chemical | Percent | Range | CAS # | Type |
| Butyl Carbitol | 21.9% | 1-50% | 112-34-5 | Glycol Ether |
| (2-(2-Butoxyethoxy)Ethanol) | | | | |
| Sodium hydroxide | 2.3% | 1-30% | 1310-73-2 | Caustic |
| Water | 68.7% | 30-70% | 7732-18-5 | Water |
| Propylene glycol | 4.8% | 0.1-30% | 57-55-6 | Diol |
| Vitech OGNTS Emulsifier | 2.3% | 0.1-20% | NA | Emulsifier |

### Example 5: By Weight (0.77 Molar Concentration NaOH in Water)

| | Actual | Percent | | Chemical |
|---|---|---|---|---|
| Chemical | Percent | Range | CAS # | Type |
| Butyl Carbitol | 30.9% | 1-50% | 112-34-5 | Glycol Ether |
| (2-(2-Butoxyethoxy)Ethanol) | | | | |
| Sodium hydroxide | 1.9% | 1-30% | 1310-73-2 | Caustic |
| Water | 64.4% | 30-70% | 7732-18-5 | Water |
| Propylene glycol | 2.5% | 0.1-30% | 57-55-6 | Diol |
| Vitech OGNTS Emulsifier | 0.3% | 0.1-20% | NA | Emulsifier |

### Example 6: By Weight (3.1 Molar Concentration NaOH in Water)

| | Actual | Percent | | Chemical |
|---|---|---|---|---|
| Chemical | Percent | Range | CAS # | Type |
| Butyl Carbitol | 15.1% | 1-50% | 112-34-5 | Glycol Ether |
| (2-(2-Butoxyethoxy)Ethanol) | | | | |
| Sodium hydroxide | 8.4% | 1-30% | 1310-73-2 | Caustic |
| Water | 68.4% | 30-70% | 7732-18-5 | Water |
| Propylene glycol | 5.5% | 0.1-30% | 57-55-6 | Diol |
| Vitech OGNTS Emulsifier | 2.6% | 0.1-20% | NA | Emulsifier |

### Example 7: By Weight (5.1 Molar Concentration NaOH in Water)

| | Actual | Percent | | Chemical |
|---|---|---|---|---|
| Chemical | Percent | Range | CAS # | Type |
| Butyl Carbitol | 14.3% | 1-50% | 112-34-5 | Glycol Ether |
| (2-(2-Butoxyethoxy)Ethanol) | | | | |
| Sodium hydroxide | 13.2% | 1-30% | 1310-73-2 | Caustic |
| Water | 64.8% | 30-70% | 7732-18-5 | Water |
| Propylene glycol | 5.2% | 0.1-30% | 57-55-6 | Diol |
| Vitech OGNTS Emulsifier | 2.5% | 0.1-20% | NA | Emulsifier |

### Example 8: By Weight (7.0 Molar Concentration NaOH in Water)

| | Actual | Percent | | Chemical |
|---|---|---|---|---|
| Chemical | Percent | Range | CAS # | Type |
| Butyl Carbitol | 13.6% | 1-50% | 112-34-5 | Glycol Ether |
| (2-(2-Butoxyethoxy)Ethanol) | | | | |
| Sodium hydroxide | 17.3% | 1-30% | 1310-73-2 | Caustic |
| Water | 61.7% | 30-70% | 7732-18-5 | Water |
| Propylene glycol | 5.0% | 0.1-30% | 57-55-6 | Diol |
| Vitech OGNTS Emulsifier | 2.4% | 0.1-20% | NA | Emulsifier |

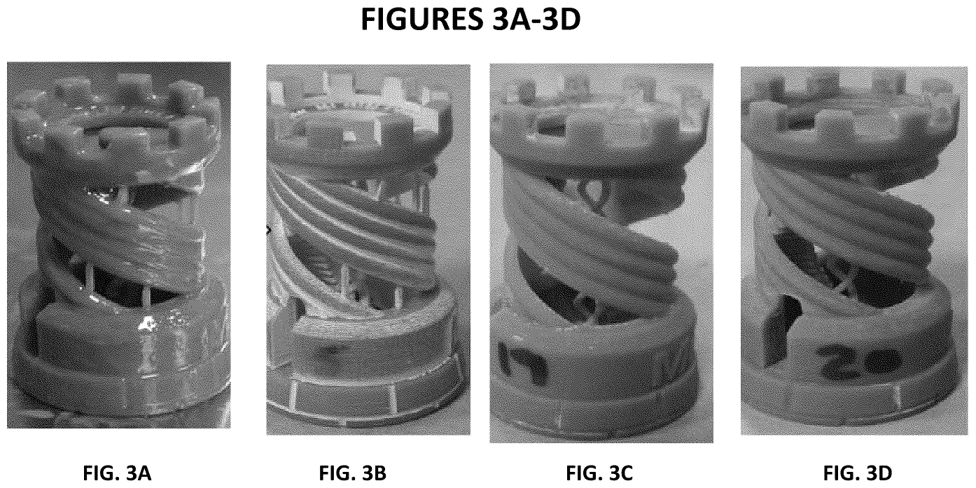

FIGS. 3A-3D depict examples of a 3D printed object (rook) made with an Accura Bluestone resin composition and how various finishing solutions may perform in removing unwanted material from the 3D printed object. Specifically, FIG. 3A depicts an example of the 3D printed object prior to application of any finishing solution.

FIG. 3B depicts an example of a 3D printed object following submersion in a finishing solution that includes no caustic or diol/triol composition within the finishing solution. The printed object was stirred within a beaker containing the finishing solution for 45 minutes at a temperature between 70-80° C. As seen within FIG. 3B, while the unwanted resin has been removed, a significant amount of unwanted white powder silica remains on the surface of the rook.

FIG. 3C depicts an example of a 3D printed object following submersion in a finishing solution having a caustic solution. In this example, the finishing solution includes 0.7 liters of Butyl Carbitol (2-(2-Butoxyethoxy)Ethanol), 1.3 L water, 365 g sodium hydroxide (^{˜}7.0 M caustic solution), and 50 g OGNTS emulsifier. Following ultrasonic, agitation at 45-50° C. of the object in the finishing solution for approximately 1 hour, the unwanted resin and a majority of the white powder silica has been removed.

FIG. 3D depicts an example of a 3D printed object following submersion in a finishing solution having a caustic solution and a diol. In this example, the finishing solution is the same solution as the example in FIG. 3C except 75 ml of propylene glycol is also included. That is, the finishing solution includes 0.7 liters of Butyl Carbitol (2-(2-Butoxyethoxy)Ethanol), 1.3 L water, 365 g sodium hydroxide (^{˜}7.0 M caustic solution), 50 g OGNTS emulsifier, and 75 ml propylene glycol. Following ultrasonic, agitation at 40-45° C. in the finishing solution for approximately 45 minutes, the unwanted resin and a majority of the white powder silica has been removed.

In comparison to the example in FIG. 3C, the visual appearance of the rook in FIG. 3D shows an even greater removal of unwanted resin and white powder silica. Additionally, a lower operating temperature for the finishing solution bath and a shorter operating time of the agitation/ultrasonic bath was employed to achieve such an improved finished product without subsequent mechanical processing acts following use of or submersion in the finishing solution, such as vigorous/labor intensive scrubbing with sandpaper, rasps, or files and/or dry/wet mechanical bead blasting to remove the remaining ceramic powder coating from the surface of the 3D printed part.

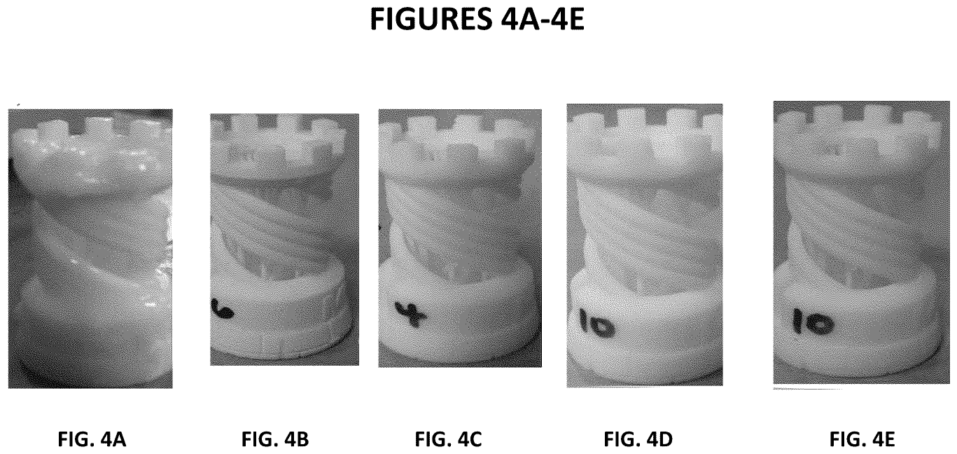

FIGS. 4A-4E depict examples of a 3D printed object (rook) made with an Accura HPC resin composition and how various finishing solutions may perform in removing unwanted material from the 3D printed object. Specifically, FIG. 4A depicts an example of the 3D printed object prior to application of any finishing solution.

FIG. 4B depicts an example of a 3D printed object following submersion in a finishing solution that includes no caustic or diol/triol composition within the solution. Following ultrasonic and agitation in the finishing solution for 5 minutes at 26-27° C., the object was brushed and washed with water. As seen within FIG. 4B, while the unwanted resin has been removed, there remains a significant amount of unwanted white powder silica on the surface of the rook.

FIG. 4C depicts an example of a 3D printed object following submersion in a finishing solution having a caustic solution. In this example, the finishing solution includes 0.7 liters of Butyl Carbitol (2-(2-Butoxyethoxy)Ethanol), 1.3 L water, 275 g sodium hydroxide (^{˜}5.0 M caustic solution), and 20 g OGNTS emulsifier. Following ultrasonic, agitation at 52-55° C. for approximately 3 minutes, the unwanted resin and a majority of the white powder silica has been removed. This example identified that at an elevated temperature of 52-55° C., most of the silica powder was successfully removed in a short amount of time, and without any subsequent mechanical acts like sanding, brushing, or bead blasting.

FIG. 4D depicts an example of a 3D printed object following submersion in a finishing solution having a caustic solution and a diol. In this example, the finishing solution includes 19.2 liters of Butyl Carbitol (2-(2-Butoxyethoxy)Ethanol), 38.4 L water, 3919 g sodium hydroxide (^{˜}2.5 M caustic solution), 200 g OGNTS emulsifier, and 6.4 L propylene glycol. Following ultrasonic, agitation at 25-27° C. for approximately 30 minutes, the unwanted resin and almost all of the white powder silica has been removed.

FIG. 4E depicts the same object from 4D that has been submitted to an additional 15 minutes of ultrasonic and agitation in the finishing solution (for a total of 45 minutes). In this example, the additional time in solution at near ambient temperature conditions removed the remaining silica from the surface of the object.

In comparison to the examples in FIGS. 4B and 4C, the visual appearance of the rook in FIGS. 4D and 4E shows an even greater removal of unwanted resin and white powder silica. Additionally, a lower operating temperature for the finishing solution bath (in comparison to FIG. 4C) was employed to achieve such an improved finished product without subsequent mechanical processing acts following use of or submersion in the finishing solution, such as vigorous/labor intensive scrubbing with sandpaper, rasps, or files and/or dry/wet mechanical bead blasting to remove the remaining ceramic powder coating from the surface of the 3D printed part. As such, while a longer submersion was used to achieve such an improved result, the result was achievable under less strenuous operating conditions (e.g. 25-27° C. versus 52-55° C. for the example depicted in FIG. 4C). In other words, the use of a finishing solution having both a caustic solution and a diol/triol may be successful in removing most, if not all, of unwanted resin and silica powder from a surface of a 3D printed object having such ceramic fillers, wherein the operating conditions are at near ambient conditions, and the process is completed without rigorous post-processing mechanical acts such as sanding, brushing, or bead blasting.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A finishing solution configured to remove unwanted material from a partially cured three-dimensional (3D) printed object, the finishing solution comprising:
a glycol ether;
a caustic solution having a caustic compound and water; and
at least one diol compound or triol compound,
wherein the finishing solution is configured to remove uncured resin and ceramic filler from a surface of the 3D printed object.

2. The finishing solution of claim 1, further comprising:
one or more emulsifiers.

3. (canceled)

4. The finishing solution of claim 2, wherein the finishing solution has:
1-50% by weight of the glycol ether;
1-30% by weight of the caustic compound;
30-70% by weight of the water;
0.1-30% by weight of the at least one diol compound or triol compound; and
0.1-20% by weight of the one or more emulsifiers.

5. The finishing solution of claim 1, wherein the caustic compound is sodium hydroxide.

6. The finishing solution of claim 1, wherein the glycol ether is butyl carbitol (2-2-butoxyethoxy)ethanol).

7. The finishing solution of claim 1, wherein the at least one diol compound or triol compound comprises propylene glycol.

8. The finishing solution of claim 1, wherein the at least one diol compound or triol compound comprises 2-methyl-2,4-pentanediol.

9. The finishing solution of claim 1, wherein the finishing solution is configured to remove at least 50% by weight of the ceramic filler from the surface of the 3D printed object without any additional subsequent mechanical act configured to remove remaining ceramic filler from the surface of the 3D printed object, and
wherein the additional subsequent mechanical act is one or more of sanding, brushing, or bead blasting of the 3D printed object.

10. (canceled)

11. The finishing solution of claim 1, wherein the finishing solution is configured to remove at least 90% by weight of the ceramic filler from the surface of the 3D printed object without any additional subsequent mechanical act configured to remove remaining ceramic filler from the surface of the 3D printed object, and
wherein the additional subsequent mechanical act is one or more of sanding, brushing, or bead blasting of the 3D printed object.

12. (canceled)

13. The finishing solution of claim 1, wherein the finishing solution is configured to remove at least 99% by weight of the ceramic filler from the surface of the 3D printed object without any additional subsequent mechanical act configured to remove remaining ceramic filler from the surface of the 3D printed object, and
wherein the additional subsequent mechanical act is one or more of sanding, brushing, or bead blasting of the 3D printed object.

14. (canceled)

15. A method of removing uncured resin and ceramic filler from a surface of a partially cured three-dimensional (3D) printed object, the method comprising:
providing a finishing solution having a glycol ether, a caustic solution comprising a caustic compound and water, and at least one diol compound or triol compound;
submerging at least a portion of the 3D printed object in the finishing solution;
agitating the portion of the 3D printed object in the finishing solution at an ultrasonic frequency; and
removing the 3D printed object from the finishing solution.

16. The method of claim 15, further comprising:
rinsing and/or drying the 3D printed object following the removing of the 3D printed object from the finishing solution.

17. The method of claim 15, wherein the finishing solution is maintained at a temperature in a range of 20-55° C. during the submerging and the agitating.

18.-19. (canceled)

20. The method of claim 15, wherein the caustic compound is sodium hydroxide,
wherein the glycol ether comprises butyl carbitol (2-2-butoxyethoxy)ethanol), and
wherein the at least one diol compound or triol compound comprises propylene glycol.

21. The method of claim 15, wherein the finishing solution further comprises one or more emulsifiers.

22. The method of claim 21, wherein the finishing solution has:
1-50% by weight of the glycol ether;
1-30% by weight of the caustic compound;
30-70% by weight of the water;
0.1-30% by weight of the at least one diol compound or triol compound; and
0.1-20% by weight of the one or more emulsifiers.

23. The method of claim 15, wherein the finishing solution removes at least 50% by weight of the ceramic filler from the portion of the 3D printed object submerged in the finishing solution without any additional subsequent mechanical act that removes remaining ceramic filler from the surface of the 3D printed object, and
wherein the additional subsequent mechanical act is one or more of sanding, brushing, or bead blasting of the 3D printed object.

24. (canceled)

25. The method of claim 15, wherein the finishing solution removes at least 90% by weight of the ceramic filler from the portion of the 3D printed object submerged in the finishing solution without any additional subsequent mechanical act that removes remaining ceramic filler from the surface of the 3D printed object, and
wherein the additional subsequent mechanical act is one or more of sanding, brushing, or bead blasting of the 3D printed object.

26. (canceled)

27. The method of claim 15, wherein the finishing solution removes at least 99% by weight of the ceramic filler from the portion of the 3D printed object submerged in the finishing solution without any additional subsequent mechanical act that removes remaining ceramic filler from the surface of the 3D printed object, and
wherein the additional subsequent mechanical act is one or more of sanding, brushing, or bead blasting of the 3D printed object.

28. (canceled)

29. A finished three-dimensional (3D) printed object formed through a process comprising:
providing a partially cured 3D printed object having an uncured resin and ceramic filler on a surface of the partially cured 3D printed object;
providing a finishing solution having a glycol ether, a caustic solution comprising a caustic compound and water, and at least one diol compound or triol compound;
submerging at least a portion of the partially cured 3D printed object in the finishing solution and agitating the portion of the 3D printed object in the finishing solution at an ultrasonic frequency, wherein the uncured resin and the ceramic filler are removed from the surface of the partially cured 3D printed object; and
removing the 3D printed object from the finishing solution to provide the finished 3D printed object.

30.-42. (canceled)
